(19) United States
(12) Patent Application Publication
(10) Pub. No.: US 2003/0086207 A1
(43) Pub. Date: May 8, 2003

(54) Disc drive suspension

(75) Inventors: Eiji Watadani, Aiko-gun (JP); Noriyuki Saito, Aiko-gun (JP); Masao Hanya, Yokohama-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: NHK Spring Co., Ltd., Yokohama-shi (JP)

(21) Appl. No.: 10/161,789

(22) Filed: Jun. 4, 2002

(30) Foreign Application Priority Data
Nov. 8, 2001 (JP) 2001-343606

(51) Int. Cl. G11B 5/48

(52) U.S. Cl. 360/244.9

(57) ABSTRACT

A pair of side rails with an L-shaped cross section are formed individually on the opposite side edge portions of a load beam. Each side rail includes a low rail portion and a high rail portion higher than the low rail portion. The low and high rail portions are situated in a region nearer to the distal end portion of the load beam with respect to its longitudinal direction than the center of gravity of the load beam.

### CROSS-REFERENCE TO RELATED APPLICATIONS

This application is based upon and claims the benefit of priority from the prior Japanese Patent Application No. 2001-343606, filed Nov. 8, 2001, the entire contents of which are incorporated herein by reference.

### BACKGROUND OF THE INVENTION

1. Field of the Invention

The present invention relates to a disc drive suspension incorporated in an information processing apparatus such as a personal computer.

2. Description of the Related Art

FIG. 14 shows a part of a hard disc drive (HDD). This disc drive comprises suspensions 3 and actuator arms 4 on which the suspensions 3 are mounted, individually. Each suspension 3 supports a magnetic head portion 2 for recording on and reading information from the recording surface of a disc 1 for use as a recording medium. The actuator arms 4 can be turned around a shaft (not shown) by means of a positioning motor (not shown).

Each suspension 3 is provided with a base plate 5, a load beam 6 extending from the base plate 5 toward the head portion 2, a flexure 7 on the load beam 6, etc. The base plate 5 is fixed to the proximal end portion of the load beam 6. The flexure 7 is fitted with a slider 8 that constitutes the head portion 2.

Conventionally, side rails 9 may be formed individually on the opposite side edge portions of the load beam 6 to enhance the bending stiffness of the beam 6. The side rails 9 are formed by bending the opposite side edge portions of the load beam 6 so that they have an L-shaped cross section.

FIG. 15 shows an example of the vibration characteristic of the suspensions 3. As shown in FIG. 15, there are a primary vibration mode (hereinafter referred to as T1) of torsion and a secondary vibration mode (T2) in the frequency domain of 8 kHz and below, for example. The sway frequency f_{S} should preferably be higher than the sampling frequency. The sway frequency is the frequency that is related to the crosswise vibration of the suspension.

Conventionally, the shock resistance has been regarded as vital to a suspension that is used in a 2.5-inch disc drive. With the development of higher-density, higher-speed discs, however, the sampling frequency has recently been increasing. Thus, the high-frequency vibration mode of the suspension, that is, a vibration mode for frequencies near the sampling frequency, has aroused a problem.

Since the sampling frequency has increased (e.g., to 8 kHz), the T2-mode for frequencies lower than the sampling frequency is a critical problem. In designing the suspension, therefore, the T2-mode, as well as the T1-mode, must be controlled.

In the conventional load beam with the side rails having the L-shaped cross section, as shown in FIG. 16, there is a substantial phase difference S between optimum values for the T1- and T2-modes. Therefore, the vibration characteristic cannot be controlled with ease, and it is hard to obtain a suspension that reconciles the T1- and T2-modes. In designing a suspension, it is profitable to lessen the phase difference S between the T1- and T2-modes.

FIG. 18 shows the result of analysis of the relation between rail height h and the phase difference S between the T1- and T2-modes in a load beam 6 that has side rails 9 with an L-shaped cross section shown in FIG. 17. As shown in FIG. 18, the smaller the height of the side rails, the smaller the phase difference S between the T1- and T2-modes is. In other words, the phase difference S can be lessened by reducing the rail height H.

However, the stiffness of the distal end of the load beam is also an essential factor to the design of a suspension. If the distal end stiffness of the load beam is low, its shock resistance in an unloaded state is inevitably low. The unloaded state is a state in which the distal end of the load beam, in a loading/unloading type disc drive, is stuck on a support member with the suspension moved beside a disc.

As shown in FIG. 19, the smaller the side rail height, the lower the distal end stiffness of the load beam is. Therefore, the stiffness (e.g., 1,200 mN/mm) needed to secure the shock resistance in the unloaded state cannot be obtained.

In order to enhance the stiffness of the suspension, side rails 9′ with a U-shaped cross section may be formed individually on the opposite side edge portions of the load beam, as shown in FIG. 20. However, the U-shaped side rails 9′, compared with the L-shaped ones, have drawbacks that their weight per unit length is greater and that forming them is more difficult. If the load beam is heavier, the sway frequency tends to lower, and its characteristic associated with the sampling frequency is critical. In order to increase the sway frequency and improve the shock resistance, the weight of the load beam must be reduced.

### BRIEF SUMMARY OF THE INVENTION

Accordingly, the object of the present invention is to provide a disc drive suspension, light in weight and of desirable vibration characteristics.

A disc drive suspension according to the present invention comprises a load beam having a proximal end portion mounted with a base plate, a distal end portion mounted with a magnetic head portion, and opposite side edge portions, and a pair of side rails with an L-shaped cross section formed individually by bending the opposite side edge portions of the load beam, each of the side rails including a low rail portion formed in a region nearer to the proximal end portion of the load beam with respect to the longitudinal direction thereof and a high rail portion higher than the low rail portion and formed in a region nearer to the distal end portion.

According to this invention, the height of the side rails having the L-shaped cross section is changed in the longitudinal direction of the load beam, whereby the vertical stiffness distribution of the load beam and the stiffness of the distal end portion can be adjusted to desired values. Since the phase difference between T1- and T2-modes is small, moreover, the vibration characteristic can be controlled with ease. Furthermore, these side rails can be made lighter in weight than side rails that have a U-shaped cross section.

Preferably, the high rail portion is formed in a region nearer to the distal end portion than the center of gravity of the load beam. According to this invention, the vertical stiffness distribution of the load beam and the stiffness of the distal end portion can be adjusted to desired values.

Preferably, moreover, the height of the low rail portion is not greater than 0.2 mm, and the height of the high rail portion is greater than 0.2 mm, for example. According to this invention, the vertical stiffness distribution of the load beam and the stiffness of the distal end portion obtained are suited to a 2.5-inch disc drive.

Preferably, moreover, a rail portion having a medium-height between those of the low and high rail portions may be formed between the low and high rail portions. According to this invention, the side rails can enjoy a wider variety of shapes.

Preferably, furthermore, the height of the high rail portion may decrease toward the distal end portion. According to this invention, the interference between the side rails and peripheral parts of the disc drive around the distal end portion of the load beam can be avoided with ease.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the embodiments given below, serve to explain the principles of the invention.

FIG. 1 is a perspective view of a disc drive suspension according to a first embodiment of the invention;

FIG. 2 is a side view schematically showing a part of the suspension shown in FIG. 1;

FIG. 3 is a sectional view of a load beam taken along line F3-F3 of FIG. 2;

FIG. 4 is a diagram showing phase differences between T1- and T2-modes for load beams of two types having low rail portions with different heights;

FIG. 5 is a diagram showing the relation between the height of the low rail portion and the phase difference between the T1- and T2-modes;

FIG. 6 is a diagram showing the relation between the height of the low rail portion and the stiffness of the distal end portion of the load beam;

FIG. 7 is a diagram showing relations between the distance from a dimple and vertical stiffness distributions for low rail portions with varied heights;

FIG. 8 is a diagram showing relations between the distance from the dimple and vertical stiffness distributions for high rail portions with varied lengths;

FIG. 9 is a perspective view of a disc drive suspension according to a second embodiment of the invention;

FIG. 10 is a side view of a part of a disc drive suspension according to a third embodiment of the invention;

FIG. 11 is a side view of a part of a disc drive suspension according to a fourth embodiment of the invention;

FIG. 12 is a side view of a part of a disc drive suspension according to a fifth embodiment of the invention;

FIG. 13 is a side view of a part of a disc drive suspension according to a sixth embodiment of the invention;

FIG. 14 is a sectional view of a part of a disc drive provided with conventional suspensions;

FIG. 15 is a diagram showing the vibration characteristic of the suspensions shown in FIG. 14;

FIG. 16 is a diagram showing the phase difference between the T1- and T2-modes of the suspension shown in FIG. 14;

FIG. 17 is a side view showing a part of a conventional load beam provided with side rails having an L-shaped cross section;

FIG. 18 is a diagram showing the relation the rail height of the load beam shown in FIG. 17 and the phase difference between T1 and T2;

FIG. 19 is a diagram showing the relation between the rail height of the load beam shown in FIG. 17 and the stiffness of its distal end portion; and

FIG. 20 is a perspective view of a part of a conventional load beam provided with side rails having a U-shaped cross section.

### DETAILED DESCRIPTION OF THE INVENTION

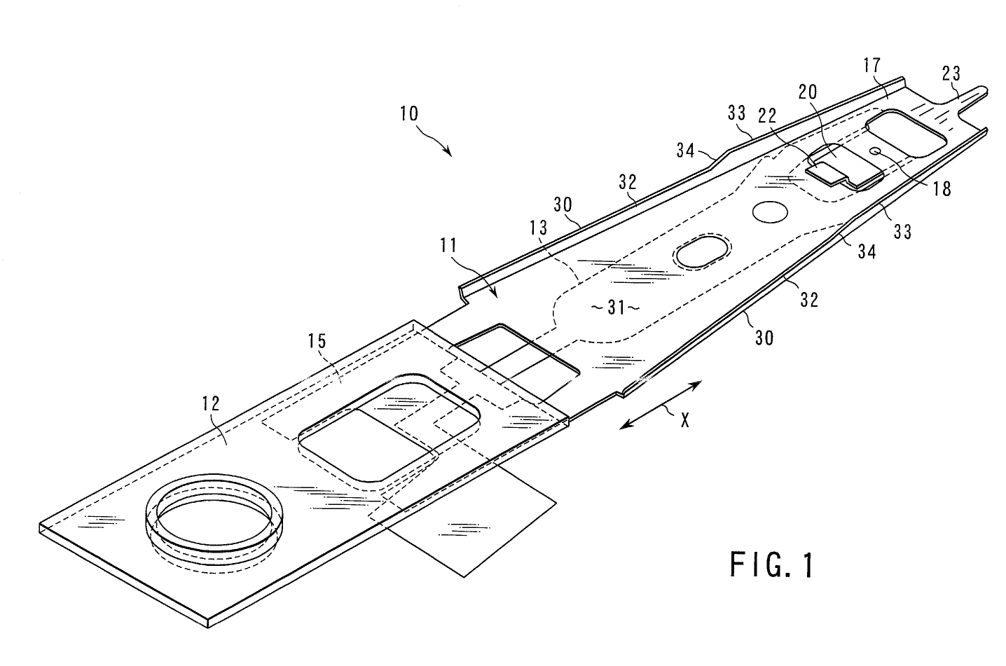

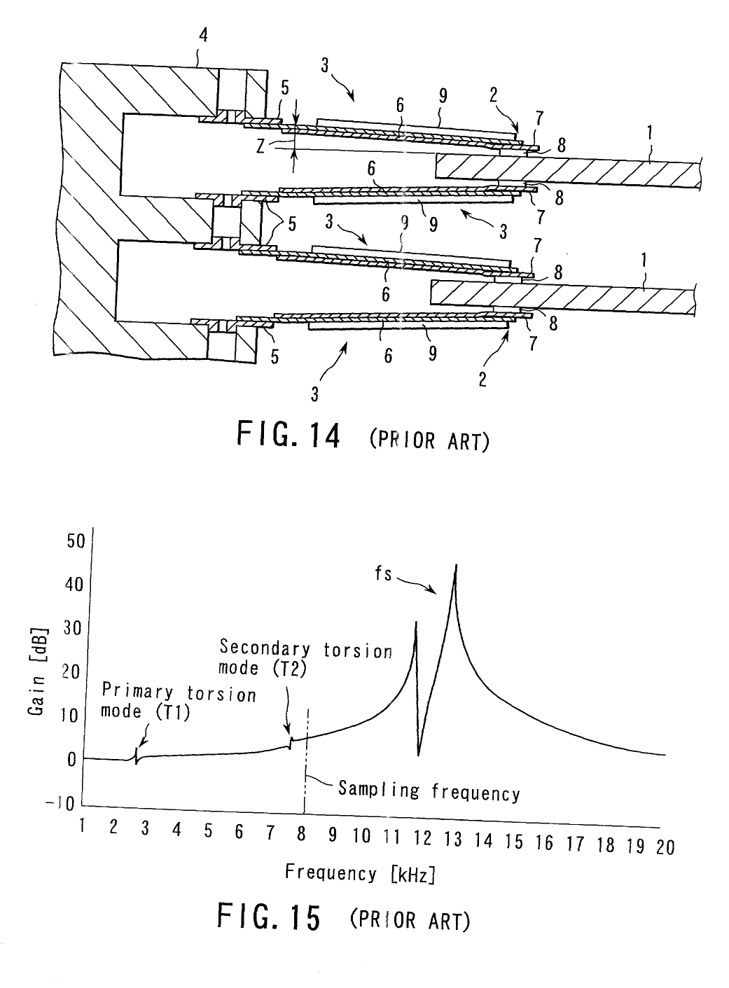

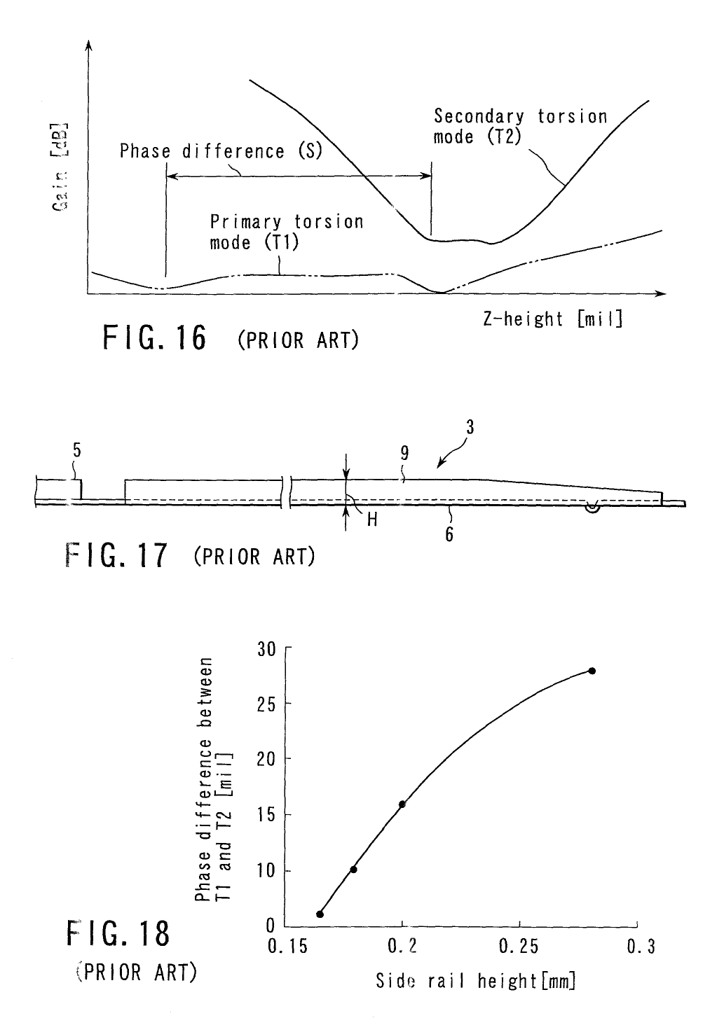

A first embodiment of the present invention will now be described with reference to FIGS. 1 to 8. The disc drive suspension 10 shown in FIG. 1 includes a load beam 11, a base plate 12, a flexure 13, etc. The suspension 10, like the conventional suspension 3 shown in FIG. 14, is fixed to an actuator arm of a disc drive. The flexure 13 extends along the load beam 11.

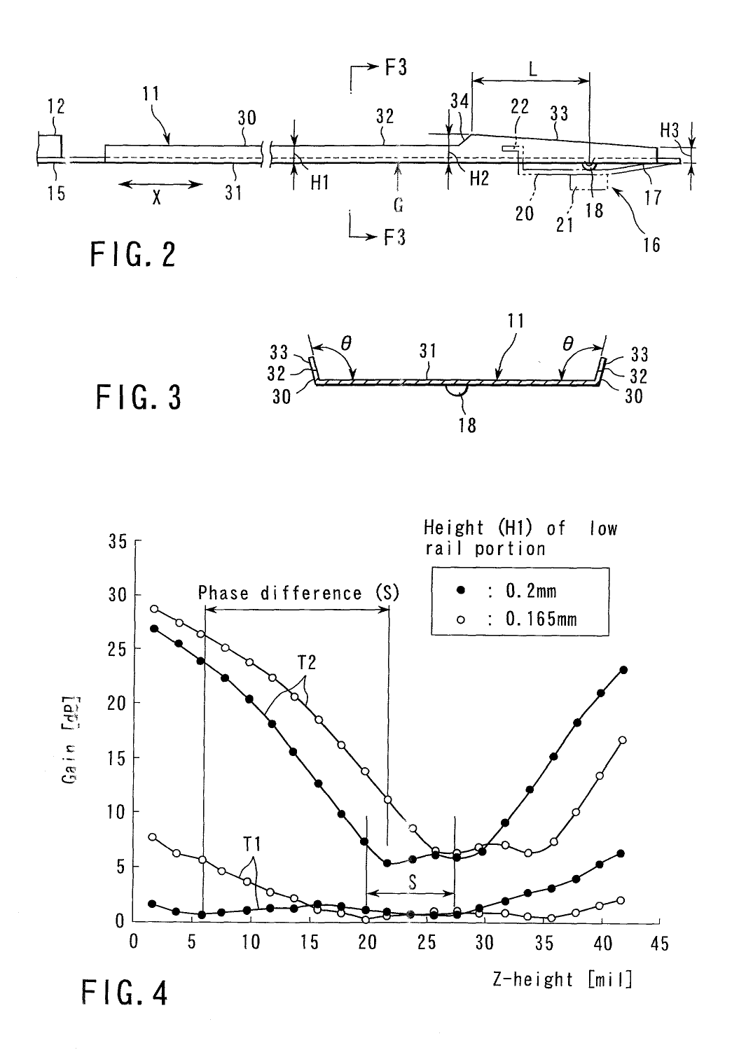

The load beam 11 includes a proximal end portion 15 on which the base plate 12 is mounted, and a distal end portion 17 on which a magnetic head portion 16 (shown in FIG. 2) is mounted. The distal end portion 17 is formed having a dimple 18. The dimple 18 projects toward the flexure 13. The flexure 13 is formed of a metal sheet as an example of a material that is thinner than the load beam 11. The thickness of the flexure 13 ranges from about 18 μm to 25 μm, while that of the load beam 11 ranges from about 30 μm to 100 μm, for example.

A tongue portion 20 that serves as a movable portion is formed on the distal end portion of the flexure 13. The tongue portion 20 can bend in the thickness direction of the flexure 13, and it is in contact with the dimple 18. The tongue portion 20 is fitted with a slider 21 that constitutes the magnetic head portion 16. The slider 21 has therein a transducer for use as a magneto-electric conversion element.

A limiter portion 22 is formed on the rear end of the tongue portion 20. The limiter portion 22 regulates the distance between the load beam 11 and the tongue portion 20 to prevent the tongue portion 20 being too distant from the load beam 11.

A pair of side rails 30, each having an L-shaped cross section, are formed individually on the opposite side edge portions of the load beam 11. As shown in FIG. 3, each side rail 30 is formed by pressing or the like in a manner such that it vertically extends at an angle θ of 90° or more to a flat portion 31, which constitutes the principal part of the load beam 11.

Each side rail 30 includes a low rail portion 32, high rail portion 33, and taper portion 34. The low rail portion 32 is formed in a region nearer to the proximal end portion 15 of the load beam 11 with respect to its longitudinal direction (along an axis X). The high rail portion 33 is formed in a region nearer to the distal end portion 17 of the load beam 11. The taper portion 34 is formed between the low and high rail portions 32 and 33. As shown in FIG. 2, the height H2 of the high rail portion 33 is greater than the height H1 of the low rail portion 32. The height of the high rail portion 33 gradually decreases toward the distal end portion 17.

FIG. 4 shows the result of comparison between phase differences S between optimal positions in T1- and T2-modes for load beams 11 of two types, of which the respective low rail portions 32 have the height Hi of 0.2 mm and 0.165 mm, individually. The height H2 of the high rail portion 33 of each load beam is adjusted to 0.28 mm. The height H3 of the distal end portion 17 of the high rail portion 33 of each load beam is adjusted to 0.165 mm. FIG. 4 indicates that the phase difference S for the load beam of which the low rail portion 32 has the height H1 of 0.165 mm is smaller than that for the load beam with H1 of 0.2 mm.

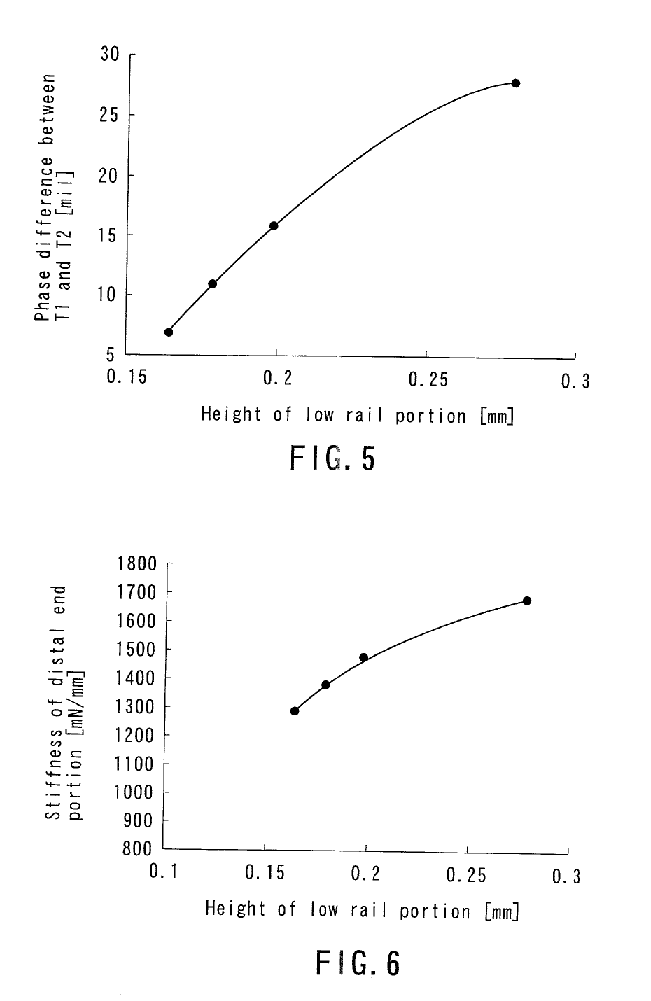

FIG. 5 shows the result of comparison between the aforesaid phase differences between the T1- and T2-modes obtained when the height H1 of the low rail portion 32 is variably adjusted to 0.165 mm, 0.18 mm, 0.20 mm, and 0.28 mm. In any of these cases, the height H2 of the high rail portion 33 is 0.28 mm. FIG. 5 indicates that the smaller the height H1 of the low rail portion 32 of the load beam, the smaller the phase difference between the T1- and T2-modes is.

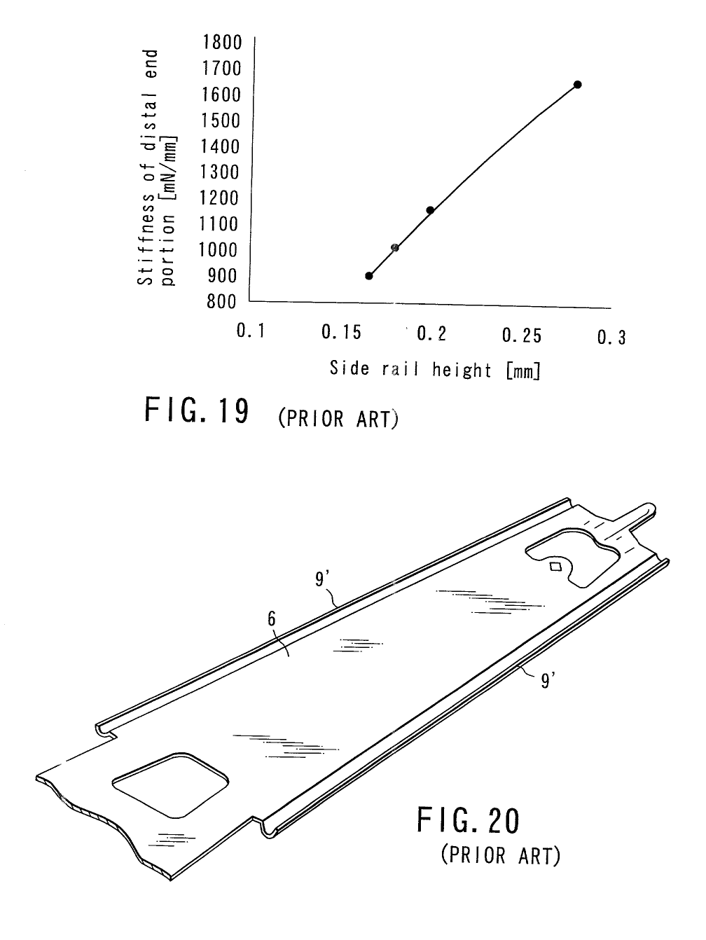

FIG. 6 shows the result of comparison for the stiffness of a region near the distal end portion 17 between load beams 11 having the aforesaid four types of side rails. As seen from FIG. 6, the value of the stiffness of the load beam 11 that has the low rail portion 32 with the height of 0.2 mm or less and the high rail portion 33 with the height more than 0.2 mm is greater enough than that of the distal end portion of the conventional side rail (shown in FIG. 19) with the height of 0.2 mm or less. More specifically, any of the load beams 11 of the four types can enjoy a stiffness higher than 1,200 mN/mm that is needed to secure shock resistance in an unloaded state.

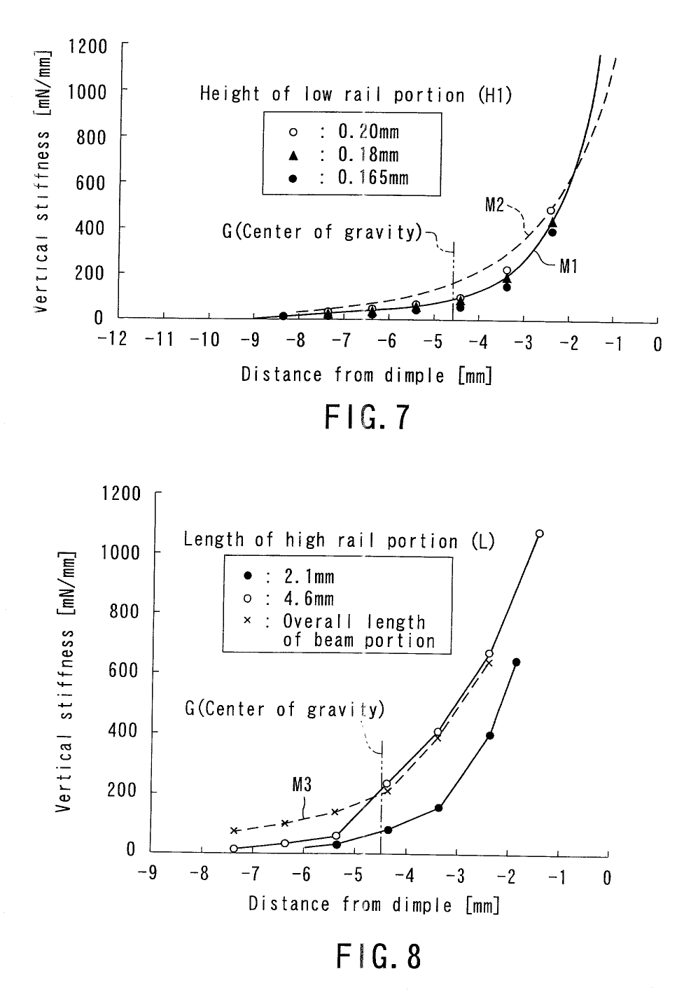

FIG. 7 shows the result of examination of the respective vertical stiffness distributions of various parts of the load beams 11 in the longitudinal direction obtained when the height Hi of the low rail portion 32 is variably adjusted to 0.165 mm, 0.18 mm, and 0.20 mm. The vertical stiffness distributions of the load beams 11 are expected to have a characteristic (represented by curve M1) such that the stiffness suddenly increases as a position beyond the center of gravity G is approached toward the dimple 18.

In the load beam having the conventional side rail, as indicated by curve M2 in FIG. 7, the stiffness of the region near the center of gravity G changes gently, which is not a desired characteristic. On the other hand, the load beams 11 of the present embodiment have desired characteristics based on curve M1.

FIG. 8 shows vertical stiffness distributions for cases where a length L from the dimple 18 of the high rail portion 33 is 4.6 mm and where it is 2.1 mm. In either case, the heights H1 and H2 of the low and high rail portions 32 and 33 are 0.165 mm and 0.28, respectively. In the case where the length L of the high rail portion 33 is 2.1 mm, the high rail portion 33 is situated nearer to the distal end portion 17 than the center of gravity G is, arid a desired vertical stiffness distribution can be obtained.

In the case where the length L of the high rail portion 33 is 4.6 mm, on the other hand, the rear part of the high rail portion 33 extends beyond the center of gravity G toward the proximal end portion 15. In this case, the characteristic M3 of the conventional side rail (shown in FIG. 17) s approached inevitably, and a desired vertical stiffness distribution cannot be obtained.

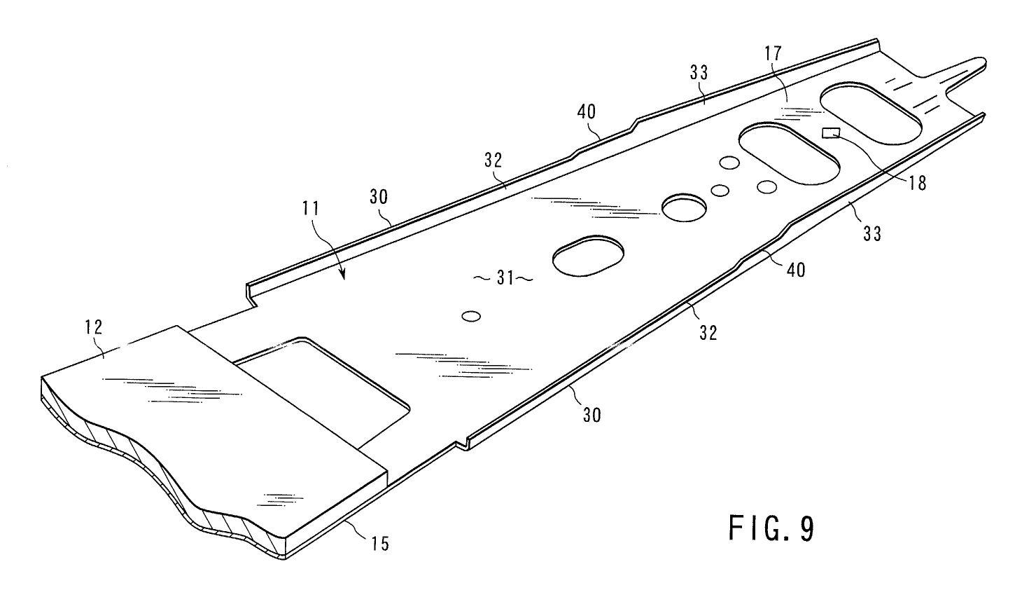

FIG. 9 shows a second embodiment of the present invention. Each side rail 30 of this embodiment has a medium-height portion 40 between a low rail portion 32 and a high rail portion 33. The portion 40 has a height between those of the rail portions 32 and 33. Thus, the rail height may be varied in a plurality of steps from a proximal end portion 15 of a load beam 11 toward a distal end portion 17.

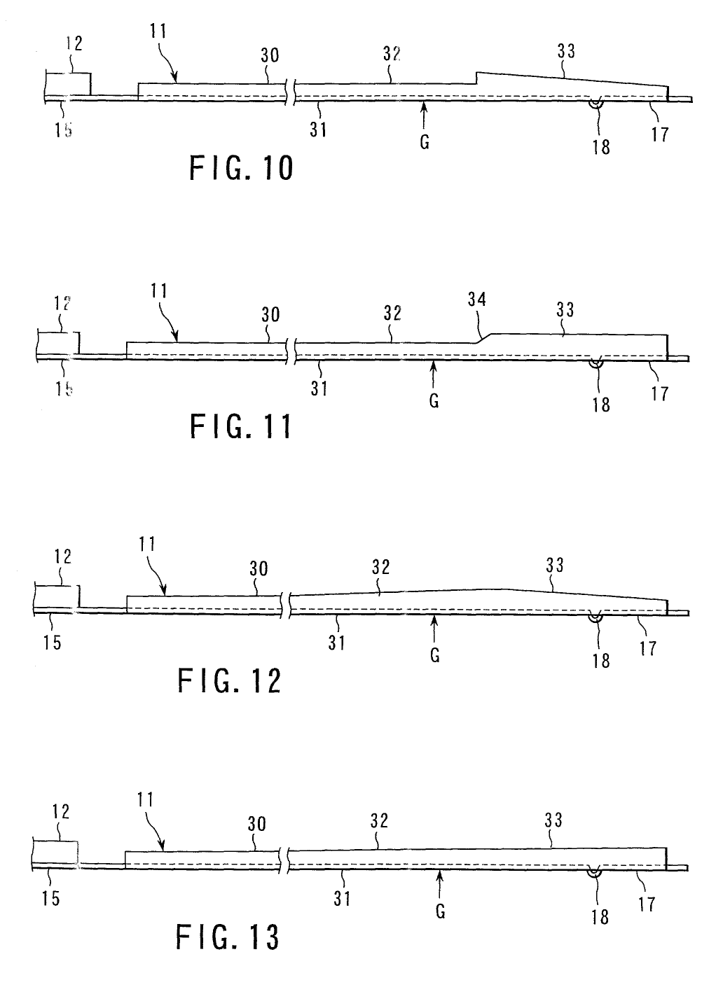

FIG. 10 shows a third embodiment of the invention. Each side rail 30 of this embodiment has a vertical portion 50 that rises substantially upright between a low rail portion 32 and a high rail portion 33.

FIG. 11 shows a fourth embodiment of the invention. In this embodiment, the height of each high rail portion 33 is substantially fixed throughout its length.

FIG. 12 shows a fifth embodiment of the invention. In each of side rails 30 of this embodiment, the height of a low rail portion 32 gradually increases from the low rail portion 32 toward a high rail portion 33. The height of the high rail portion 33 gradually decreases toward a distal end portion 17.

FIG. 13 shows a sixth embodiment of the invention. Each side rail 30 of this embodiment is tapered so that its height decreases from the distal end portion 17 of load beam 11 to the proximal end portion 15.

In carrying out the present invention, it is to be understood that the components of the invention, including the specific shapes of the side rails, as well as the form of the load beam, may be changed or modified without departing from the scope or spirit of the invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A disc drive suspension comprising:
a load beam having a proximal end portion mounted with a base plate, a distal end portion mounted with a magnetic head portion, and opposite side edge portions; and
a pair of side rails with an L-shaped cross section formed individually by bending the opposite side edge portions of the load beam,
each said side rail including a low rail portion formed in a region nearer to the proximal end portion of the load beam with respect to the longitudinal direction thereof and a high rail portion higher than the low rail portion and formed in a region nearer to the distal end portion.

2. A suspension according to claim 1, wherein said high rail portion is formed in a region nearer to the distal end portion than the center of gravity of the load beam is.

3. A suspension according to claim 1, wherein the height of said low rail portion is not greater than 0.2 mm, and the height of the high rail portion is greater than 0.2 mm.

4. A suspension according to claim 1, wherein a medium-height rail portion having a height intermediate between those of the low and nigh rail portions is formed between the low and high rail portions.

5. A suspension according to claim 1, wherein the height of said high rail portion decreases toward the distal end portion.
